(19) United States
(12) Patent Application Publication
(10) Pub. No.: US 2008/0078334 A1
(43) Pub. Date: Apr. 3, 2008

(54) KIT AND METHOD FOR CREATING PET-RELATED ARTWORK

(76) Inventor: Tammy Zaiko, Saratoga Springs, NY (US)

Correspondence Address: DUANE C. BLAKE, 67 STERLING ROAD, WESTWOOD, MA, 02090, US

(21) Appl. No.: 11/538,163

(22) Filed: Oct. 3, 2006

(51) Int. Cl. A01K 29/00

(52) U.S. Cl. 119/702

(57) ABSTRACT

A pet-related artwork kit comprising an artistic canvas, a supply of printing medium, a transparent sheet, a pet engagement device, and a container to hold the kit contents. The kit can also include an order form instructing a processing facility to transfer the artistic canvas image to other items and a container to hold and protect the pet-related artwork while being transported to the processing facility. The present invention also discloses a method of producing the pet-related artwork comprising the steps of placing the artistic canvas on a surface, putting paint on the artistic canvas, covering the paint and the artistic canvas with a transparent sheet, having a pet create impressions on the artistic canvas by manipulating the transparent sheet, and removing the transparent sheet from the artistic canvas. This method can also include using the container to hold the kit and to transport the pet-related artwork to and from a processing facility that transfers the pet-related artwork image to different items.

### DESCRIPTION OF PRIOR ART

A pet owner's emotional attachment to a family pet is often very special and personally fulfilling. To further strengthen or share that emotional attachment, pet owners have created many ways of displaying attachment to their pets. For example, owners frequently take pictures of their pets, or have paintings of their pets portrayed by professional artists. Typically, the pet is not involved in the creation of the artwork or photographs.

### BACKGROUND OF THE INVENTION

The present invention relates to both a kit and process for making pet-related artwork, which may allow a pet owner and pet to engage in projects for creating pet-related artwork together. The resulting pet-related artwork may simply be displayed by the owner or further utilized in a number of different capacities.

Individualized pet-related artwork may conform in many mediums. In one particular embodiment, the pet-related invention may comprise an artistic canvas upon which an image is created by the pet using a method of having a pet and owner utilize paint and artistic canvas to create pet-related artwork. In at least one embodiment, the methods disclosed include steps to allow the pet and owner to create the artwork in an efficient and especially clean manner. The process also discloses other methods to create other pet-related keepsakes based on the pet-related image created in one embodiment of the invention.

One method of producing pet-related artwork comprises placing paint directly on the animal's paws and having them walk on a canvas. In this process, while a painting may be created by a pet, the creation process, however, can be very messy. Pet owners need to be rightfully concerned about damaging furniture and other household items of value, which can be ruined during the creation of the pet-related artwork. In addition to this problem, many pets refuse to engage in the process at all, further frustrating their owners.

There remains a need, therefore, for a pet-related artwork kit and method of producing pet-related artwork that can be used by pet owners, in an easy manner, with a minimal amount of clean up and stress on the pet and owner. The method ideally needs to be orchestrated at a minimal cost, and benefit from modern computer based imaging and delivery methods.

With the addition of computer based imaging and modern timely delivery methods, it is now possible to broaden the variety of items that can be created, imprinted, and delivered, with a pet-related image, and delivered to pet owners in a timely fashion. For example, modern imaging systems allow a single image to be reproduced and replicated on a wide variety of mediums. One example might include coffee mugs, or t-shirt. Although the present invention is not limited to these embodiments. The tools and equipment used for this imaging and printing are well known in the art, however, the equipment is expensive and the processes to complete the tasks are complex. Typically, the traits of the process force the imaging to be performed in a distant, centralized processing facility. The problem of integration of creating a simple piece of pet-related artwork with the modern features and benefits of modern imaging systems is addressed herein.

### BRIEF SUMMARY OF THE INVENTION

To address the shortcomings in the present state of the industry, the present invention incorporates many helpful features. For example, the present invention discloses a kit for use in making pet-related artwork which comprises an artistic canvas, a supply of a printing medium to be utilized with the artistic canvas, a protective transparent sheet to be put over the printing medium and the artistic canvas, a pet engagement device to keep the pet entertained while creating a impression on the artistic canvas, and a container to hold the kit and transport the pet-related artwork to and from a processing facility that can transfer the pet-related artwork image to other items.

In other embodiments, the pet engagement device can be a pet treat a pet toy or any other device that would serve to hold to attention of the pet while the pet-related artwork images are being created. Examples of pet engagement devices contemplated include, but are not limited to dog treats, tennis balls, stuffed animals, bones, catnip and bones.

In another embodiment, the kit can comprise a container to hold the kit and a separate container, such as an envelope, a metal or cardboard tube, or any other suitable carrier that may be used to transport the pet-related artwork to and from a processing facility. The container may be sold pre-labeled and pre-postage paid, if required.

In other embodiments, the kit can also be enhanced to include a drop cloth to protect the area where the pet-related artwork is being created, including instructions defining the process to create the pet-related artwork, wet naps of any variety to clean the animal's feet and a frame to display the artwork.

The present invention also discloses a method of producing pet-related artwork comprising the steps of placing the artistic canvas on a surface, putting paint on the artistic canvas, covering the paint and the artistic canvas with a transparent sheet, having a pet create impressions on the artistic canvas by manipulating the transparent sheet and the paint, removing the transparent sheet from the artistic canvas revealing a completed pet-related artwork. The transparent sheet may comprise any suitable material, including, but not limited to, plastics and other appropriate substances.

Yet another embodiment of the invention is that it enables pet-related artwork to be created while also keeping the pet clean. This invention allows the pet-related artwork to be created without the pet coming into contact with the printing medium.

A further embodiment of the invention is that it allows the person helping the pet to easily see the artwork as it is being created. This ensures that the activity is not prematurely stopped, or allowed to proceed beyond the time necessary to create an appealing picture.

In another embodiment, the methods of this invention can be enhanced to include providing the kit with all the material to create the pet-related artwork. By providing all of the elements necessary to create the artwork, this eliminates the need for the pet owner to locate and buy kit components individually. This kit may or may not include any element of the kit, including boxing and postage.

Another aspect of the invention is that the methods disclosed are well defined in a written manual included in the kit, or purchased separately, to ensure that the pet-related artwork creation process is completely understood by the pet owner.

Other embodiment of the invention is that it provides methods for other objects to be made from single piece of pet-related artwork. For example, the pet-created images from the artistic canvas can be transposed onto other objects such as coffee mugs, mouse pads or t-shirts.

Another aspect of the invention is to provide a packaging container that can be used to contain the kit contents for sale as well as serve as a shipping container for a completed piece of artwork. Both containers with and without postage are contemplated.

Further objects advantages of this invention will be apparent from the following detailed description of a presently preferred embodiment which is illustrated schematically in the accompanying drawings. These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated embodiments of the invention. The foregoing has outlined some of the more pertinent objects of this invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE SEVERAL VIEWS OF THE DRAWINGS

FIG. 1 is an exploded perspective view of the kit components of one embodiment of the invention.

FIG. 2 is an exploded perspective view of the kit components of another embodiment of the invention.

FIG. 3 is a flow chart outlining the method of creating the pet-related artwork according to one embodiment of the invention.

FIG. 4 is a side view of an embodiment being used with dog paws.

FIG. 5 is a view of a completed pet-related artwork in a frame.

FIG. 6 is a flow chart outlining the method of transporting the pet-related artwork to a processing facility according to one embodiment of the invention.

FIG. 7 is an illustration of pet-related artwork that was created using a technique of the present invention.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

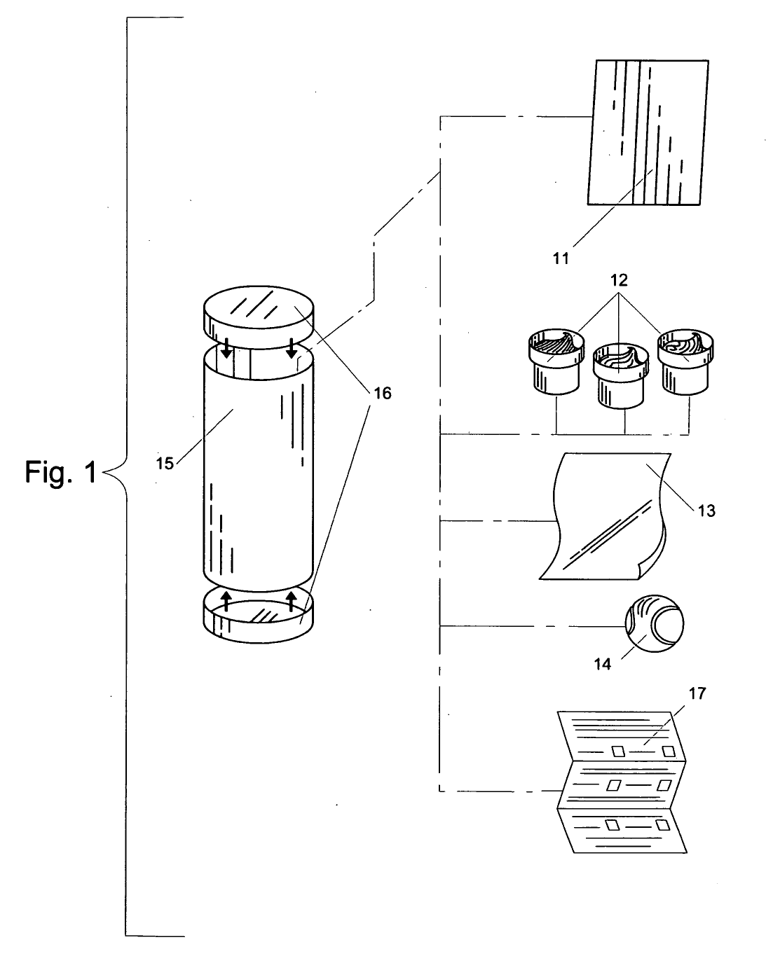

As shown in FIG. 1, one embodiment of the kit comprises at least one artistic canvas 11, a supply of a printing medium 12, a transparent sheet 13, a pet engagement device 14, and a container 15 to hold the kit components. The artistic canvas 11 is of a sufficient rigidity to withstand a normal house pet stepping on it without the artistic canvas wrinkling. The artistic canvas 11 must also be of sufficient pliability to fit into the container 15. The rigidity of a typical cereal box is sufficient to meet both needs. The artistic canvas can be of any shape, however, all shapes that conform to the requirements of a normal retailer's shelve and to the normal dimension of picture frames are contemplated. A size of 8 inches by 10 inches is not required, but is sufficient. The artistic canvas can be made from a woven material such as canvas, but can also be made from other materials such as cardboard, paper, plastic or any other material that can receive a printing medium. The printing medium 12 can be paint such as a non-toxic acrylic paint, an ink, dye or any other medium that can transfer color to the artistic canvas. Non-toxic coatings are preferred. In this embodiment, small containers of primary color paints are supplied in closable containers within the kit. The containers can be made from plastic, glass, metal, paper or foil and can of any shape to include, but not be limited to, tubes, cups or cylinders. The transparent sheet 13 can be a transparent sheet of film. The dimension of the transparent sheet should be large enough to cover the artistic canvas with sufficient overlap to prevent exposing paint on the artistic canvas when the transparent sheet is manipulated by the pet. The transparent sheet can be made from, but not be limited to, plastic, paper, woven material or any other thin material, as is described infra. A transparent sheet dimension of 1.5 times the dimensions of the artistic canvas is not required, but is sufficient. The pet engagement device, such as a tennis ball 14, is used to keep the pet's attention. Although the container 15 can be of any shape or size to hold the contents of the kit, FIG. 1 shows one embodiment of the container 15 which comprises an open cylindrical container with end caps 16 to fit on both ends of the container. The container 15 can be made from any material suitable for containing the kit contents. Suitable materials include, but are not be limited to, cardboard, plastic, nylon, metal, wood or any combination of these materials. The container 15 can have any shape that will retain the kit contents. Suitable shapes for the container include, but are not be limited to, cylinders, boxes, molded plastic or any combination of these materials.

As shown in FIG. 1, one embodiment of the kit includes using the container 15 as both the sales packaging for the kit as well as the container to transport the pet-related artwork to a processing facility. In this embodiment, the container should of a shape and made from a material that will hold the kit contents and also contain and protect the pet-related artwork during transportation to the processing facility. Transport can consist of, but is not be limited to, mailing, commercial overnight carrier, personal courier or other method to move a package from one location to another. In this embodiment, an order form 17 is also included. The container and order form are used to mail the completed pet-related artwork to a processing facility that can display the pet-related artwork or create images of the pet-related artwork and transfer that image to other items. Processing facilities that utilize digital imagining, photo imagining or other image capture methods are contemplated.

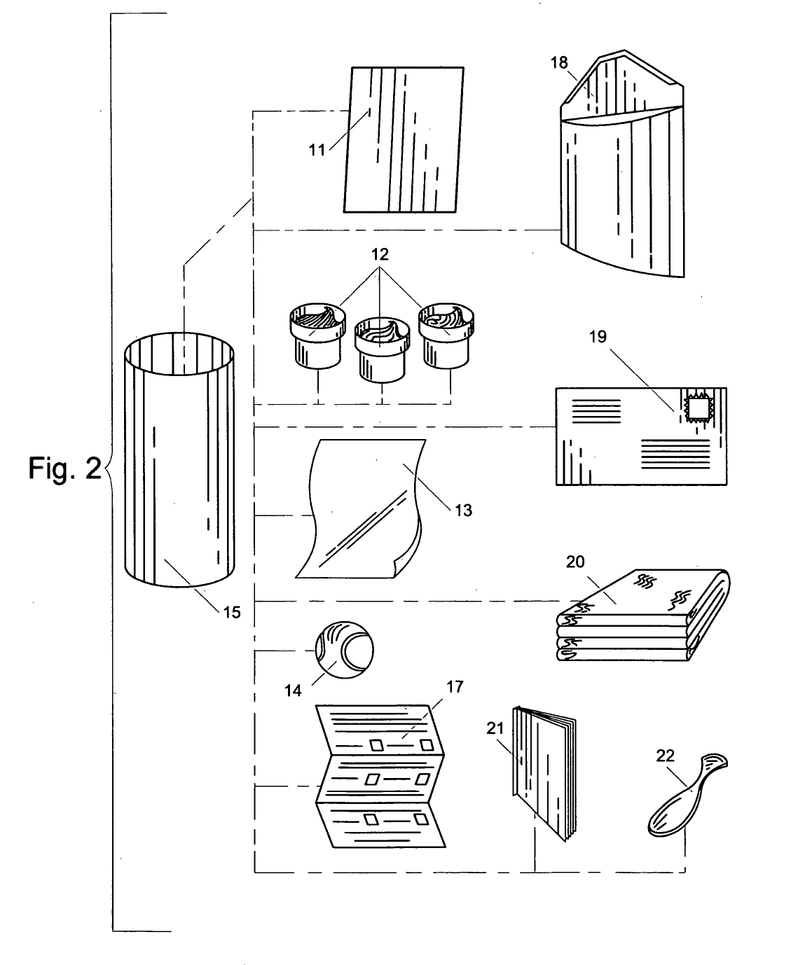

As shown in FIG. 2, another embodiment of the kit includes a container to hold the kit and a second separate container 18 and a label 19 to mail the pet-related artwork to and from a processing facility. This second container can be an envelope, a box or other container capable of transporting the pet-related artwork. The label can be a separate label or a preprinted label on the separate container.

Another embodiment of the kit includes providing a drop cloth 20 in the kit. The drop cloth 20 in FIG. 2 is folded. The drop cloth is a material to act as a drop cloth and cover the floor or other items in the area where the pet-related artwork is created. The drop cloth can be made from, but should not be limited to comprising, woven material, paper, plastic or similar materials.

Another embodiment of the kit includes providing an instruction manual 21 in the kit. The instruction manual describes the steps required to create the pet-related artwork and also describes other helpful methods to include ways to mix the printing medium to obtain different shades of colors. The instruction manual may be in the form of, but is not limited to the form of a printed book, a digital storage medium or an instructional video.

Yet another embodiment of the kit includes providing an applicator 22, such as a plastic spoon, to aid in applying the printing medium to the artistic canvas. The applicator can be made from any material such as wood or other material capable of being made into a shape to aid in the application of printing medium to the artistic canvas. The applicator may be made in the shape of a spoon, a knife, paddle, a scoop or other shape sufficient to aid applying the printing medium to the artistic canvas.

Another embodiment of the kit includes providing a means to clean printing medium that might get on the pet or the surrounding environment. This cleaning means can be an alcohol moistened sheet such as a baby wipe, a wet napkin or pet specific cleaning products.

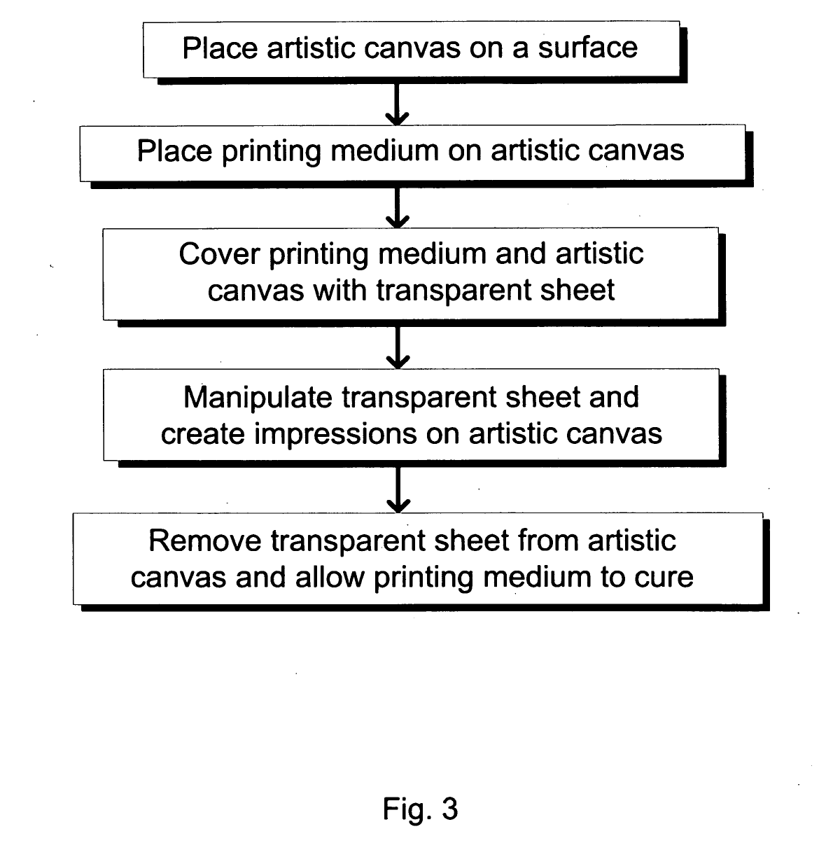

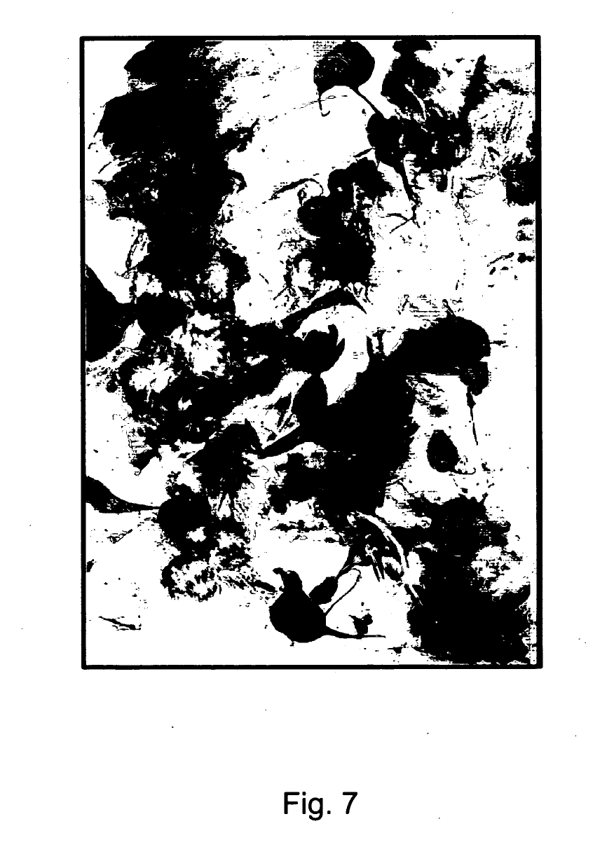

As shown in FIG. 3, the present invention also discloses the method of producing pet-related artwork comprising the steps of placing the artistic canvas on a surface, putting paint on the artistic canvas, covering the paint and the artistic canvas with a transparent sheet, having a pet create impressions on the artistic canvas by manipulating the transparent sheet and the paint, removing the transparent sheet from the artistic canvas revealing a completed pet-related artwork. The pet-related artwork can then cure allowing the printing medium to dry. FIG. 7 shows an illustration of pet-related artwork that was created using an embodiment of this method.

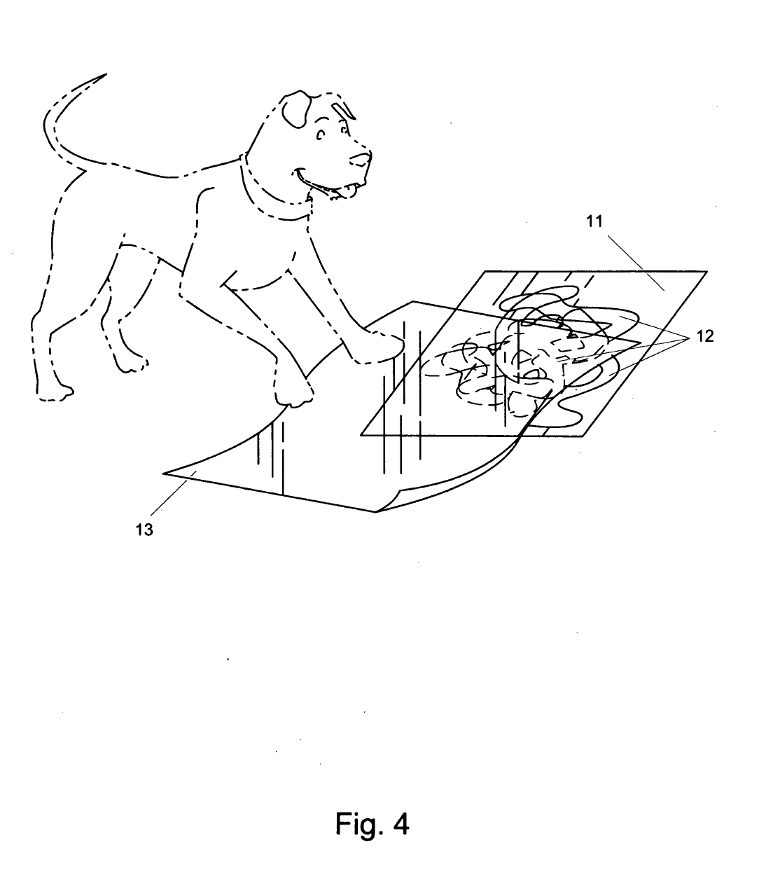

The first step of the disclosed method is to place the artistic canvas 11 on a surface, as shown in FIG. 4. Placing the artistic canvas on a flat surface that can easily be cleaned is suggested although not necessary. Surfaces such as a floor of tile, linoleum or concrete are suggested as good places to place the artistic canvas while creating the pet-related artwork.

In another embodiment, a drop cloth may be placed under the artistic canvas to cover the underlying surface and protect it from paint that might get transferred off the face of the artistic canvas.

The second step is to place a printing medium onto the artistic canvas as shown in FIG. 4. In this embodiment, paint is placed on the artistic canvas in proportions, colors and locations to make the completed pet-related artwork more appealing. The pet may be more inspired by certain paint selections and placement and pet owners may be more willing to display artwork containing certain color patterns.

Once the paint is placed on the artistic canvas, the third step is to place the transparent sheet over both the artistic canvas and the paint on the artistic canvas. FIG. 4 shows an example of how the transparent sheet covers the paint and the artistic canvas. FIG. 4 has an exaggerated spacing between the artistic canvas and the transparent sheet for illustration purposes only. The transparent sheet is placed directly or almost directly on the paint.

Once the paint is covered with the transparent sheet, the forth step is to have the pet manipulate the transparent sheet by applying pressure to the transparent sheet and paint, pushing the paint along the surface of the artistic canvas. FIG. 4 shows an example of how the pet's front paws would manipulate the transparent sheet. The pet is encouraged to continue to manipulate the transparent sheet and the paint until the pet, or the pet owner believes the pet-related artwork is completed. The transparent sheet allows the pet and the pet owner to see the progress of the pet-related artwork as it is created. The transparency assists in the determination as to when the pet should be taken away from the transparent sheet and the work.

To assist the pet owner during this step, a pet engagement device is provided. The pet engagement device provides a means to keep the pet engaged at the spot of the artistic canvas and can be used to encourage the pet to move over and manipulate the transparent sheet and paint on the artistic canvas. Pet engagement devices can include, but are not limited to, tennis balls, bones, sticks and stuffed toys. Other attention getting devices can be used to achieve the same affect, such as a pet treat.

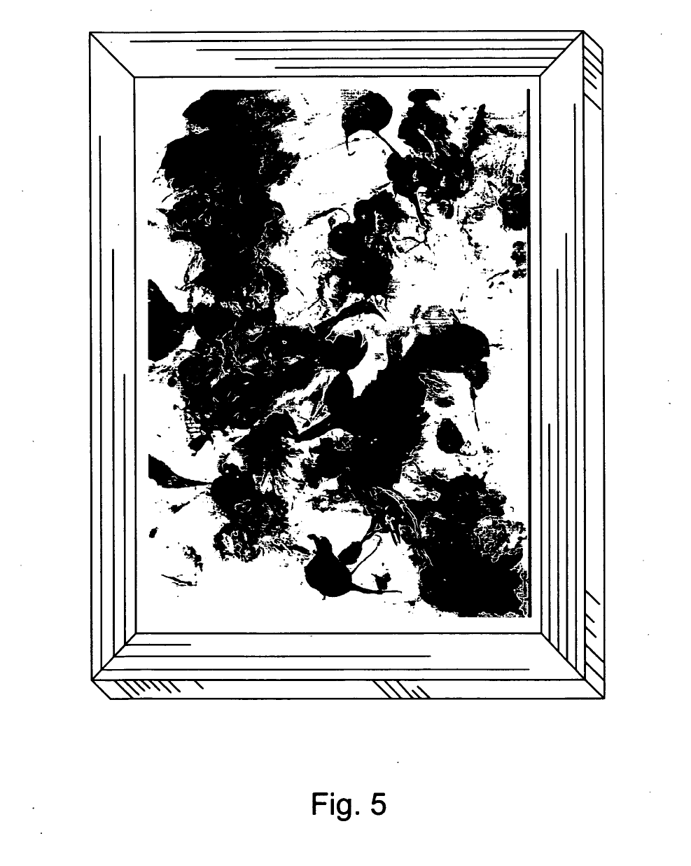

Once the pet stops manipulating the transparent sheet, the fifth step consists of removing the transparent sheet from the artistic canvas and the paint. This exposes the face of the artistic canvas now covered with paint. The artistic canvas and the paint are cured creating a completed pet-related artwork. FIG. 5 shows a completed piece of pet-related artwork placed in a frame.

While the transparent sheet specifications in the description and embodiments of the present application are fully described, it is understood that these specifications are taught for exemplary purposes only, as many other embodiments are contemplated by the inventor. For example, the invention may comprise any number of types or thicknesses of transparent sheets, which may be constructed using a wide variety of materials, with varying thicknesses, both of which will necessarily be dictated according to the exact objectives source, and the size of the pet used in creating the pet-related artwork.

For example, while it is considered to be within the scope of this invention to utilize a transparent sheet with only one layer, one may, according to the size of the animal used in making the pet artwork, utilize more then one layer, with between 2 and 15 layers of transparent sheets being used, as needed. If one layer is utilized, a thickness of between 0.1 mm and 2.5 mm is contemplated.

Alternatively, in a preferred embodiment of the invention, considering the size of the pet, it may be useful to consider a transparent sheet of only one layer, but that one layer comprising a greater thickness, to ensure that the animal's nails do not penetrate the transparent sheeting. Typically, the larger the animal, the thicker the transparent sheet or more layers of sheeting required. The inventor contemplates that several kit varieties may be sold, each using a different thickness of transparent sheet, anticipating the size of the pet creating the pet-related artwork. For example, a 15 pound breed of Pug will necessarily use a different transparent sheeting thickness than a 150 pound breed of Saint Bernard. It will be intuitive to those of skill in the art that different layers or different thickness will be used in construction of the transparent sheet to suit the objectives sought, and this difference in layers will be reflected in multiple variety of kits sold to consumers. In addition, additional layers may be added to the particular transparent sheet layering, dictated by the objectives of the particular project. This multi-layered transparent sheeting can then be further layered upon one or more other transparent sheets, in a manner that creates a durable composite, and further, eliminates any breaking through of the pet's nails, and thus eliminating of paint mess in the painting area. In one embodiment of the invention, the inventor has discovered a particular configuration of widely available over-the-counter transparent sheet withstood the penetration of a 15 pound pet.

As is apparent to those in the art, a number of materials may satisfy the embodiments taught in the present invention. For example, embodiments of a transparent sheet of the present invention may be constructed from plastics, glasses, aluminum silicates, ionomer resins, metals, rubbers, fiber materials, synthetic film, fabric, ceramics or combinations of these materials. For a sample illustration of a present embodiment, a one layer polycarbonate plastic sheet may be utilized using methods that are well known in the art. This list of materials for use of the transparent sheet herein is only exemplary, and should not be construed to be exclusive or limiting of the invention. For example, many other suitable materials, which are species of the aforementioned materials, exist. And any comprehensive lists of such are cumbersome and unnecessary for descriptive purposes. But as an example, while not intending to limit the invention, such a list of suitable materials may include polybenzoxazole (PBO), polybenzothiazole (PBT) polymers or related copolymers, thermoplastic polymers (polyethylene, polycarbonate, etc.), thermosetting polymers (vinyl ester, polyvinyl butyral (PVB), epoxy resins, polyvinyl urethanes, etc.), elastomers (polybutadiene, natural rubber, etc.).

Another embodiment of the invention includes the utilization of foot coverings for the pet to inhibit the nails of the pet penetrating the transparent sheet. The foot coverings contemplated include, but are not limited to, glove-like or boot-like coverings that can easily be put on the pet's paws while still allowing the pet to manipulate the transparent sheet, and thus, paint underneath the sheet. Materials from which the paw coverings can be made include, but are not limited to, plastic, cloth, rubber, paper or any other suitable material.

Other preferred versions of the invention are also considered in constructing the transparent sheet materials of the present invention utilizing a plurality of these suitable transparent sheets, but are not to be construed to be limited to any particular plurality of species. For example, transparent sheets, comprised of plastics are available from E. I. du Pont de Nemours & Co., Wilmington, Del., or by the Dow Company under various trademarks.

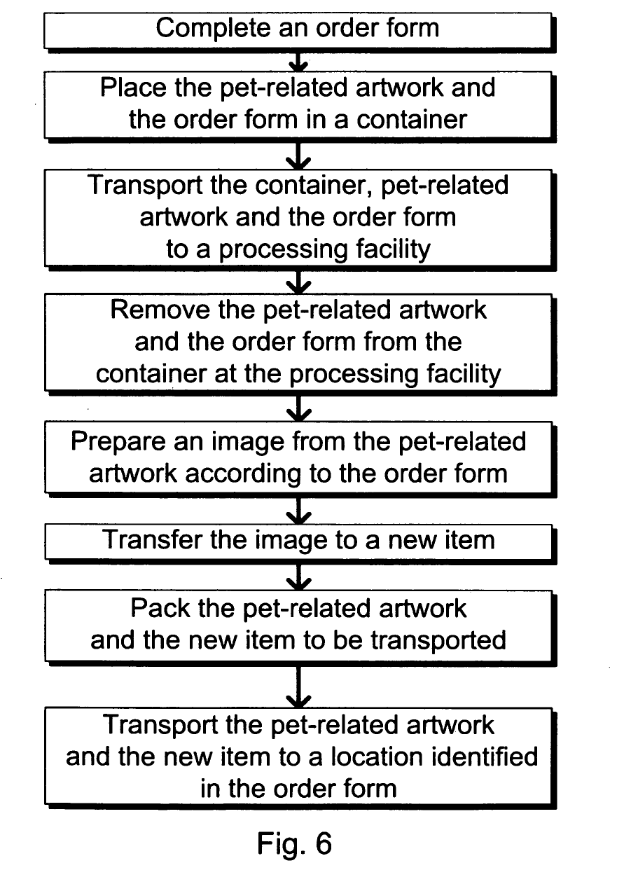

In addition to the above steps, as shown in FIG. 6, the method may further include the steps of completing an order form, placing the pet pet-related artwork and the order form in a container, placing a transportation label to the outside of the container, transporting the container, pet-related artwork and order form to a processing facility, removing the pet-related artwork and the order form from the container at the processing facility, preparing an image from the pet-related artwork according to the order form, transferring the image to a new item, packing the pet-related artwork and the new item to be transported and transporting the pet-related artwork and the new item to a location identified in the order form. These additional steps may be used with many different embodiments of this invention to include those described above and shown in FIG. 1 and FIG. 2.

The processing facility uses scanners, cameras or other imaging equipment to copy the image of the pet-related artwork. This image is used to transfers the image onto other items. These other items include, but are not limited to, digital images, coffee cups, t-shirts and calendars, mouse pads, note cards, magnets, aprons and key chains.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. In as much as the present disclosure includes that contained in the appended claims as well as that of the foregoing description. Although this invention has been described in the above forms with a certain degree of particularity, it is understood that the present disclosure has been made only by way of example and numerous changes in the details of construction and combination and arrangement of parts may be resorted to without departing from the spirit and scope of the invention.

What I claim is:

1. A kit for making pet-related artwork, said kit comprising an artistic canvas; a supply of a printing medium; a transparent sheet; and a pet engagement device.

2. A kit as set forth in claim 1 wherein said transparent sheet is of sufficient size to cover said artistic canvas.

3. A kit as set forth in claim 1 further comprising a drop cloth larger in size than said artistic canvas.

4. A kit as set forth in claim 1 further comprising an applicator to apply the printing medium to the artistic canvas.

5. A kit as set forth in claim 1 further comprising an instruction manual defining the steps necessary to create the pet-related artwork.

6. A kit as set forth in claim 1 further comprising means to clean printing medium off of pet.

7. A kit as set forth in claim 1 further comprising a processing facility and an order form to be completed to select which services will be performed by the processing facility.

8. A kit as set forth in claim 7 further comprises a second container to transport the pet-related artwork and the order form to the processing facility.

9. A method of producing a pet-related artwork comprising the steps of: placing an artistic canvas on a surface; placing a printing medium on the artistic canvas; covering the printing medium and the artistic canvas with a transparent sheet; manipulating the transparent sheet to create impressions on the artistic canvas; and removing the transparent sheet from the artistic canvas and allowing the printing medium to cure.

10. A method of producing a pet-related artwork as set forth in claim 9 further comprising the step of providing a kit comprising: the artistic canvas; the supply of a printing medium to be applied to the artistic canvas; the transparent sheet to be placed over print medium; the pet engagement device to engage pet; and a first container to hold the kit.

11. A method of producing a pet-related artwork as set forth in claim 9 further comprising the steps of: completing an order form; placing the pet-related artwork and the order form in a first container and placing a transportation label on the outside of the first container; transporting the first container and the order form to a processing facility; removing the pet-related artwork and the order form from the first container at the processing facility; preparing an image from the pet-related artwork according to the order form; transferring the image to a new item at the processing facility; packing the pet-related artwork and the new item to be transported; and transporting the pet-related artwork and the new item to a location identified in the order form.

12. A method of producing a pet-related artwork as set forth in claim 11 further comprising the step of providing a kit comprising: the artistic canvas; the supply of the printing medium to be applied to the artistic canvas, the transparent sheet to be placed over print medium; the pet engagement device to engage pet; the first container to hold the kit; the order form; and the transportation label.

13. A method of producing a pet-related artwork as set forth in claim 12 further comprising the steps of providing a drop cloth and placing the drop cloth under the artistic canvas.

14. A method of producing a pet-related artwork as set forth in claim 12 further comprising the step of providing an applicator; using the applicator to apply the printing medium to the artistic canvas; and providing an instruction manual describing the steps to create the pet-related artwork.

15. A method of producing a pet-related artwork as set forth in claim 9 further comprising the steps of: completing an order form; placing the pet-related artwork and the order form in a second container and placing a transportation label on the outside of the second container; transporting the second container and the order form to a processing facility; removing the pet-related artwork and the order form from the second container at the processing facility; preparing an image from the pet-related artwork according to the order form; transferring the image to a new item at the processing facility; packing the pet-related artwork and the new item to be transported; and transporting the pet-related artwork and the new item to a location identified in the order form.

16. A method of producing a pet-related artwork as set forth in claim 15 further comprising the step of providing a kit comprising: the artistic canvas; the supply of a printing medium to be applied to the artistic canvas; the transparent sheet to be placed over print medium; the pet engagement device to engage pet; a first container to hold the kit; the second container to serve as a shipping container for the pet-related artwork; the order form; and the transportation label.

17. A method of producing a pet-related artwork as set forth in claim 16 further comprising the steps of providing a drop cloth and placing the drop cloth under the artistic canvas.

18. A method of producing a pet-related artwork as set forth in claim 16 further comprising the steps of providing an applicator; using the applicator to apply the printing medium to the artistic canvas; and providing an instruction manual describing the steps to create the pet-related artwork.
